(19) United States
(12) Patent Application Publication
(10) Pub. No.: US 2004/0207138 A1
(43) Pub. Date: Oct. 21, 2004

(54) Vice

(76) Inventor: Ichiro Kitaura, Itami-shi Hyogo (JP)

Correspondence Address: JORDAN AND HAMBURG LLP, 122 EAST 42ND STREET, SUITE 4000, NEW YORK, NY, 10168, US

(21) Appl. No.: 10/488,240

(22) PCT Filed: Sep. 6, 2002
(86) PCT No.: PCT/JP02/09100

(30) Foreign Application Priority Data
Sep. 14, 2001 (JP) 2001-279621

(51) Int. Cl. B23Q 3/08

(52) U.S. Cl. 269/25

(57) ABSTRACT

A vice is comprising a movable clamp member that can be positioned and fixed in a prescribed position corresponding to the size of a workpiece, before fixing the workpiece, wherein the mechanism for achieving this positioning and fixing operation can be simplified, and the stroke of a fluid pressure cylinder can be shortened. This vice (1) comprises: a guiding and fixing mechanism (13) capable of guiding a movable clamp member (4) movably in a prescribed direction with respect to a movable base member (10) in the main body of the vice (2), and also capable of fixing same in a releasable fashion; a first serration (53) formed in the movable base member (10), a second serration (54) formed in the movable clamp member (4) so as to be intermeshable with the first serration (53), a guide groove (55), an anchor member (56) disposed slidably in the guide groove (55), and a plurality of bolts (57) capable of fixing the movable clamp member (4) to the anchor member (56) in a state where the first and second serrations (53, 54) are intermeshed.

### TECHNICAL FIELD

The present invention relates to a vice, and more particularly, to a vice capable of fixing a workpiece by causing a movable clamp member to move to a prescribed position corresponding to the size of the workpiece, and then driving the movable clamp member in a clamping action.

### BACKGROUND ART

Conventionally, a vice for fixing a workpiece to be subjected to machining by sandwiching same from either side comprises: a main body of the vice, a fixed clamp member which is fixed to the main body of the vice, and a movable clamp member which is provided opposing the fixed clamp member, the movable clamp member being advanced towards the fixed clamp member and the workpiece thus being held between and fixed by the fixed clamp member and the movable clamp member. Driving means for causing the movable clamp member to advance towards and withdraw from the fixed clamp member may be mechanical means wherein a handle attached to the vice is rotated manually, and this rotational force is converted to a driving force in the advancing or withdrawing direction, thereby driving the movable clamp member, or it may be means based on a fluid pressure cylinder, such as a hydraulic or pneumatic cylinder, or the like.

In a vice as described above, it is possible to fix workpieces of various sizes within a prescribed range. However, when fixing relatively small workpieces, the distance of motion of the movable clamp member towards the fixed clamp member (in the clamping direction) inevitably increases, and in the case where the driving means is based on mechanical means as described above, it is necessary to turn the handle a large number of times, and hence the efficiency of the workpiece fixing operation is poor. If the driving means is based on a fluid pressure cylinder, then it is necessary to increase the stroke of the fluid pressure cylinder, and hence the size of the fluid pressure cylinder increases, placing limitations on the installation surface area and bringing disadvantages in terms of equipment costs.

In order to resolve the aforementioned problems, for example, in the vice disclosed in Japanese Patent Application Laid-open No. H9-1467, a fixed clamp member is provided in one end portion of the main body of the vice, a driving block opposing the fixed clamp member is provided in the other end portion of the main body of the vice, and the driving block comprises a movable clamp member, and driving means, such as a pneumatic cylinder, or the like, for driving the movable clamp member in a direction towards or away from the fixed clamp member. Furthermore, a rack is provided on one side of the main body, a hook member which is engagable with the rack is provided on one side of the driving block, and when the driving block is moved to an appropriate position adjacent to the workpiece prior to fixing the workpiece, the hook member simultaneously engages with the rack, and the driving block can be registered in a desired position corresponding to the size of the workpiece.

After the driving block has been registered in position, the movable clamp member is driven in the clamping direction by driving means provided in the driving block, and the workpiece is fixed by being held between the fixed clamp member and the movable clamp member. When releasing the workpiece from its fixed state, the movable clamp member is driven in a direction away from the fixed clamp member (clamp releasing direction) by the driving means, thereby releasing the fixing of the workpiece.

When fixing a relatively large workpiece, a release lever provided in the main body of the vice is pulled, thereby releasing the engagement between the rack and the hook member, and the driving block is moved manually in the clamp releasing direction, thus separating the movable clamp member from the fixed clamp member by a prescribed distance, before setting the workpiece in the vice.

Next, the problems to be solved by the present invention are described. In the vice disclosed in the aforementioned patent publication, it is possible to fix a workpiece by driving the movable clamp member by the driving means in the clamping direction, after the driving block has been registered at a position adjacent to the workpiece, but since it is necessary to provide a rack and hook member for registering the driving block in position, and a disengagement mechanism, such as a release lever, or the like, for releasing the engagement between the rack and hook member, the structure becomes complicated, which is disadvantageous from the viewpoint of manufacturing costs.

Moreover, since the driving block comprises driving means, such as a pneumatic cylinder, or the like, the driving block is relatively heavy, but in cases where a large number of workpieces are being fixed in a plurality of vices, in particular, the fact that the driving block has to move before the workpiece is fixed causes the efficiency of the workpiece fixing operation to decline, and also causes fatigue in operating staff.

The object of the present invention is to achieve a constitution wherein the movable clamp member can be registered and fixed in a prescribed position corresponding to the size of a workpiece, prior to fixing the workpiece, to simplify the mechanism for achieving this positioning and fixing operation, to improve the efficiency of the workpiece fixing operation, and to reduce the stroke of a fluid pressure cylinder which drives the clamping action of the movable clamp member. Further objects of the present invention will become apparent from the description of the embodiment of the invention.

### DISCLOSURE OF THE INVENTION

A vice according to the present invention is comprising a vice main body having a base surface whereon a workpiece can be set, a fixed clamp member provided in a fixed manner on this vice main body, and a movable clamp member capable of moving in a prescribed direction towards or away from the fixed clamp member with keeping its face toward same; characterized by comprising: a movable base member disposed inside the vice main body and having a length in the prescribed direction; a fluid pressure cylinder capable of driving the movable base member in the prescribed direction; a guiding mechanism for guiding the movable base member movably in the prescribed direction, with respect to the vice main body; and a guiding and fixing mechanism capable of guiding the movable clamp member movably in the prescribed direction with respect to the movable base member, and capable of fixing the movable clamp member in a releasable fashion.

When clamping a workpiece, after setting the workpiece on the base surface of the vice main body, the fixing of the movable clamp member to the movable base member by means of the guiding and fixing mechanism is released, and the movable clamp member becomes movable in the prescribed direction towards or away from the fixed clamp member. Thereupon, the movable clamp member is moved manually in the direction towards the fixed clamp member (the clamping direction), the movable clamp member approaches the workpiece, and the workpiece is held substantially between the fixed clamp member and the movable clamp member. Here, the movable clamp member is guided movably in the prescribed direction with respect to the movable base member, by means of the guiding and fixing mechanism, and movement in other directions is prevented. Thereupon, the movable clamp member is fixed to the movable base member by means of the guiding and fixing mechanism.

Next, when the movable base member is driven in the clamping direction by the fluid pressure cylinder, since the movable clamp member is fixed to the movable base member by the guiding and fixing mechanism, the workpiece is held and fixed tightly between the fixed clamp member and the movable clamp member. Therefore, since the distance between the fixed clamp member and the movable clamp member can be adjusted by moving the movable clamp member in the prescribed direction in accordance with the size of the workpiece, before fixing the workpiece in position, there is no need to provide a long stroke in the fluid pressure cylinder.

When releasing the workpiece, the fixing of the workpiece is released by driving the movable base member in the direction whereby the movable clamp member moves away from the fixed clamp member (clamp releasing direction) by means of the fluid pressure cylinder.

According to the present invention, when fixing a workpiece, since it is possible to fix the movable clamp member to the movable base member after moving the movable clamp member in the prescribed direction with respect to the movable base member, by means of the guiding and fixing mechanism, and substantially holding the workpiece between the fixed clamp member and the movable clamp member, then it is possible to reduce the stroke of the fluid pressure cylinder for driving the movable base member in the clamping direction. Therefore, the vice can be made smaller, and installation cost can be decreased. Since the movable clamp member alone is moved before fixing the workpiece, the efficiency of the task of fixing the workpiece is improved, and hence the burden on the operator can be reduced.

Next, preferable constitutions relating to the present invention are described.

a) The guiding and fixing mechanism comprises: a first serration formed such that a plurality of teeth are provided orthogonally to the prescribed direction, in the side of the base surface of the movable base member; a second serration formed in the side of the base surface of the movable clamp member, so as to be intermeshable with the first serration; a guide groove formed in the movable base member and extending in the prescribed direction; an anchor member disposed slidably in this guiding groove; and a plurality of bolts capable of fixing the movable clamp member to the anchor member in a state where the first and second serrations are intermeshed.

When fixing the workpiece, the plurality of bolts are loosened and the movable clamp member is separated from the movable base member in a direction moving away from the base surface, whilst maintaining the connection between the movable clamp member and the anchor member. In this case, since the intermeshing between the first serration on the movable base member and the second serration on the movable clamp member is released, the fixing between the movable clamp member and the movable base member is released.

On the other hand, the anchor member is provided slidably in a guide groove formed in the movable base member and extending in the prescribed direction, the anchor member and the movable clamp member being coupled by means of a plurality of bolts. Therefore, the movable clamp member is moved together with the anchor member, relatively with respect to the movable base member, and the movable clamp member is approached to the workpiece, whereby the workpiece can be held substantially between the fixed clamp member and the movable clamp member.

Thereupon, after causing the first and second serrations to intermesh, the plurality of bolts are tightened, thereby fixing the movable clamp member to the movable base member, and the movable base member is driven in the clamping direction by the fluid pressure cylinder, thus fixing the workpiece. When releasing the workpiece, the movable base member is driven in the clamp releasing direction by the fluid pressure cylinder, thus releasing the workpiece.

In this way, after moving the movable clamp member in the prescribed direction with respect to the movable base member, the movable clamp member is fixed to the anchor member by means of the plurality of bolts, with the first and second serrations being in an intermeshed state, and hence the movable clamp member can be fixed at a desired position on the movable base member, in accordance with the size of the workpiece.

Accordingly, since it is possible to fix the workpiece by driving the movable clamp member by means of the fluid pressure cylinder after substantially holding the workpiece between the fixed clamp member and the movable clamp member, then it is possible to shorten the stroke of the fluid pressure cylinder. Consequently, the vice can be made more compact in size, and benefits in equipment costs can be obtained.

Moreover, since the movable clamp member can be fixed at a desired position on the movable base member, by fastening the plurality of bolts after causing the first and second serrations to intermesh, and since this fixing can be released simply by loosening the plurality of bolts, then it is not necessary to provide a special mechanism for releasing this fixing, and hence the structure of the guiding and fixing mechanism can be simplified. Furthermore, the external shape of the vice can also be simplified.

b) A composition is adopted wherein, after releasing the fixing of the movable clamp member by means of the guiding and fixing mechanism, the movable clamp member is moved relatively together with the anchor member, with respect to the movable base member, a workpiece is held substantially between the fixed clamp member and the movable clamp member, and the first and second serrations are caused to intermesh, whereupon the movable clamp member is fixed to the movable base member by means of the plurality of bolts. Therefore, similar beneficial effects to those mentioned above can be obtained.

c) The fluid pressure cylinder is a hydraulic cylinder. Therefore, from a state where the workpiece is held substantially between the fixed clamp member and the movable clamp member, the workpiece can be held and fixed tightly by driving the movable base member by means of the hydraulic cylinder.

### BRIEF DESCRIPTION OF THE DRAWINGS

FIG. 1 is a front view of a vice relating to an embodiment of the present invention;

FIG. 2 is a plan view of the vice;

FIG. 3 is a front view of the vice (partial cross-sectional view);

FIG. 4 is a cross-sectional view along line IV-IV in FIG. 2 (workpiece fixed state);

FIG. 5 is a right-hand side view of FIG. 1; and

FIG. 6 is a diagram corresponding to FIG. 4 wherein the workpiece has been released from a fixed state.

### MOST PREFERRED EMBODIMENT OF THE INVENTION

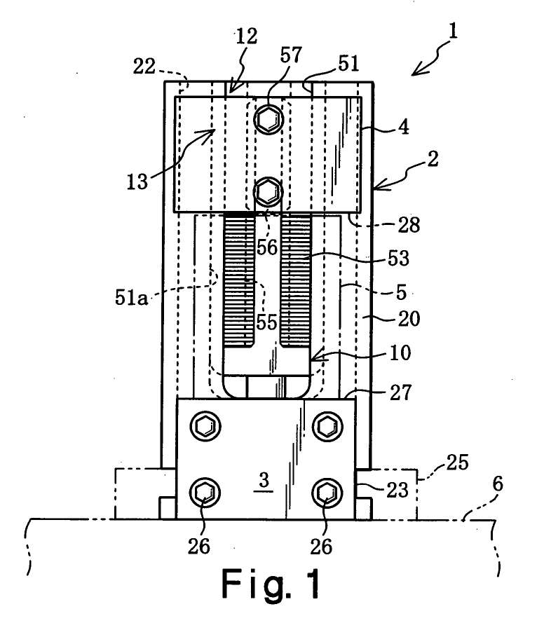

Next, a most preferred embodiment of the present invention will be described. This embodiment is one example of a case where the present invention is applied to an upright (vertical) vice for fixing a workpiece to be machined to the upper side of a workpiece pallet. The upper side, lower side, left-hand side, right-hand side, front side and rear side in FIG. 1 are respectively described below as such.

As shown in FIG. 1, the vice 1 comprises a vice main body 2, a fixed clamp member 3 provided in a fixed manner on the lower end portion of the vice main body 2, and a movable clamp member 4 capable of moving in an upward and downward direction for respectively advancing towards and moving away from the fixed clamp member 3, wherein the vice 1 fixes the workpiece 5 by holding same between the fixed clamp member 3 and the movable clamp member 4.

As shown in FIG. 1 to FIG. 4, moreover, the vice 1 comprises a movable base member 10 provided inside the vice main body 2 and having a length in the vertical direction, a hydraulic cylinder 11 (fluid pressure cylinder) capable of driving the movable base member 10 upwards and downwards in a vertical direction, a guiding mechanism 12 for guiding the movable base member 10 such that it can move upwards and downwards with respect to the vice main body 2, and a guiding and fixing mechanism 13 capable of guiding the movable clamp member 4 such that it can move upwards and downwards with respect to the movable base member 10, and also capable of fixing and releasing the movable clamp member 4.

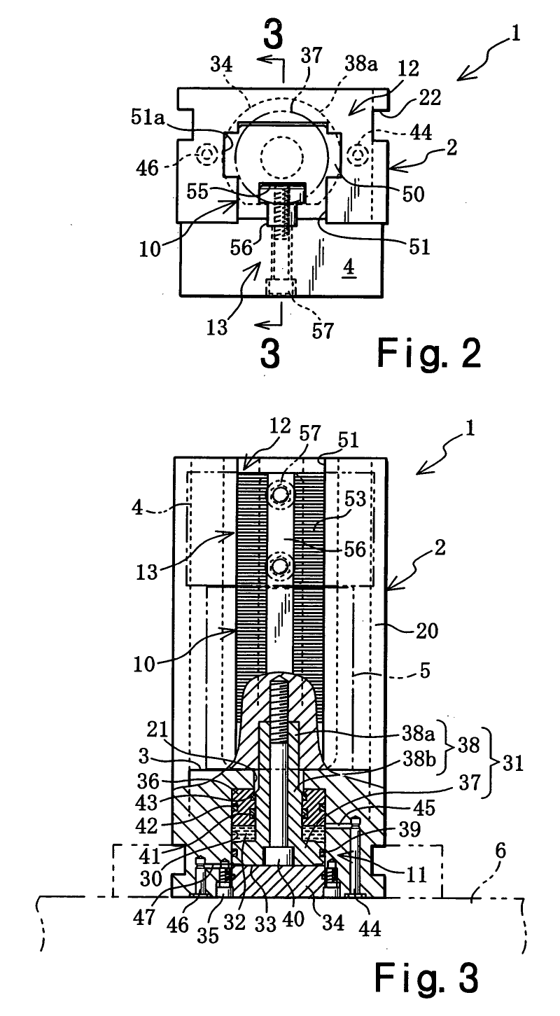

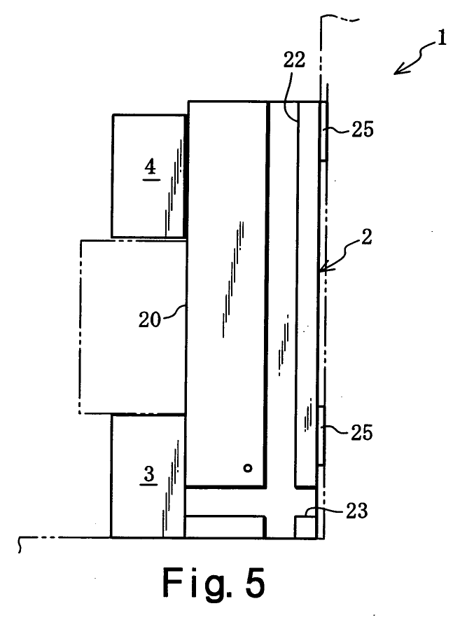

As shown in FIG. 1 to FIG. 6, the vice main body 2 has an approximately rectangular column shape extending in the vertical direction, a base surface 20 on which a workpiece 5 can be set being formed on the front surface of the central portion of the vice main body 2, in the vertical direction thereof. As shown in FIG. 2 to FIG. 4, a guide groove 51 of the guiding mechanism 12 which is open towards the front side is formed extending in the vertical direction in approximately the upper two-thirds of the vice main body 2, a cylinder hole 30 of the hydraulic cylinder 11, which is open at the lower end thereof, is formed in the lower end portion of the vice main body 2, and the guide groove 51 and cylinder hole 30 are connected by means of a communicating hole 21. An installation groove 22 extending the vertical direction, and an installation groove 23 extending in the front/rear direction are formed respectively in both the left and right-hand sides of the vice main body 2, and two key members 24 for positioning are also provided, in upper and lower positions, in the rear face of the vice main body 2. As shown in FIG. 1, in the present embodiment, the vice main body 2 is fixed to the upper surface of a work pallet 6 by means of installation fixtures 25 fitted into the left and right-hand installation grooves 23.

The fixed clamp member 3 is an approximately square shaped member, and this fixed clamp member 3 is fixed to the front face of the lower end portion of the vice main body 2, by means of four bolts 26. A receiving face 27 for receiving and holding a workpiece is formed on the upper end face of the fixed clamp member 3, and when a workpiece 5 is fixed, the workpiece 5 rests on this receiving face 27.

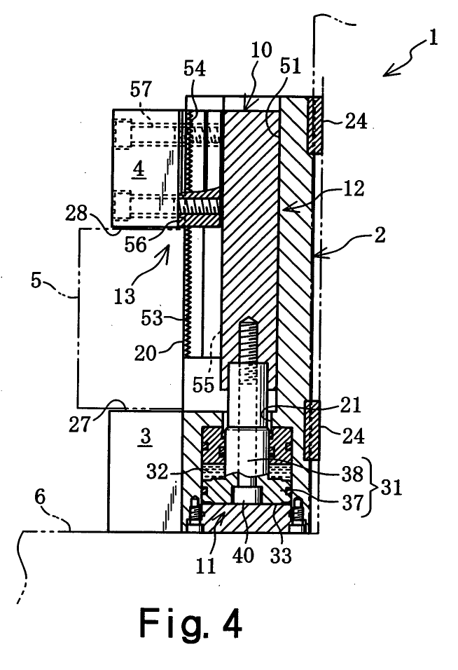

The movable clamp member 4 is an approximately square shaped member, and this movable clamp member 4 can be fixed in the central portion thereof in the lateral direction by two bolts 57, an upper and lower bolt, in a releasable manner, on an anchor member 56 of the guiding and fixing mechanism 13, and it can be released from same as illustrated in FIG. 3. A pressing face 28 for holding and fixing a workpiece 5 in conjunction with the receiving face 27 is formed on the lower end face of the movable clamp member 4. A second serration 54 of the guiding and fixing mechanism 13, described hereinafter, is formed on the rear side of the movable clamp member 4. As shown in FIG. 3 and FIG. 4, the hydraulic cylinder 11 comprises a cylinder hole 30, a piston member 31 as an output member, a clamping side oil chamber 32 for generating a clamping force, and a clamp releasing oil chamber 33 for generating a clamp releasing force, and the like.

An end wall member 34 which closes the cylinder hole 30 is fitted inside the lower end of the cylinder hole 30, and this end wall member 34 is fixed to the vice main body 2 by a plurality of bolts 35. A ring-shaped member 36 is fitted internally into the upper end portion of the cylinder hole 30.

The piston member 31 is formed integrally with a piston 37 and a piston rod 38. The piston 37 is fitted internally in a slidable fashion in the cylinder hole 30, and a seal member 39 is fitted on the piston 37. The piston rod 38 has a small diameter section 38a in the upper half thereof and a large diameter section 38b in the lower half thereof, the small diameter section 38a extending upwards, passing through the communicating hole 21, and being connected to the lower end portion of the movable base member 10 by a bolt 40, and the large diameter section 38b being provided internally in the cylinder hole 30 and passing slidably through the ring-shaped member 36. A seal member 41 is fitted between the large diameter section 38b and the ring-shaped member 36, and a seal member 42 is also fitted between the ring-shaped member 36 and cylinder hole 30. A dust seal 43 is installed on the inner circumference of the upper end portion of the ring-shaped member 36, in order to prevent dust, chippings, or the like, from entering inside the cylinder hole 30, via the communicating hole 21.

The clamping side oil chamber 32 is formed by means of the cylinder hole 30 and the ring-shaped member 36 on the upper side of the piston 37, and hydraulic pressure is supplied to this clamping side oil chamber 32 via a hydraulic pressure port 44 and an oil passage 45. The clamping releasing side oil chamber 33 is formed by the cylinder hole 30 and the ring-shaped member 34 on the lower side of the piston 37, and hydraulic pressure is supplied to this clamp releasing side oil chamber 33 via a hydraulic pressure port 46 and an oil passage 47.

Next, the movable base member 10 and the guiding mechanism 12 will be described. As shown in FIG. 1 to FIG. 4, the movable base member 10 is a bar-shaped member having a prescribed length in the vertical direction, and the movable base member 10 is disposed inside the vice main body 2.

Projecting sections 50 projecting in the vertical direction are formed on both the left and right-hand sides of the movable base member 10. A first serration 53 of the guiding and fixing mechanism 13, described hereinafter, and a guide groove 55 are formed on the front side of the movable clamp member 10.

The guiding mechanism 12 comprises a guide groove 51 formed in the vice main body 2, and this guide groove 51 extends by a prescribed length in the vertical direction and an engaging groove 51a with which a projecting section 50 can engage is formed extending in a vertical direction on both the left and right-hand inner sides of the guide groove 51. The movable base member 10 is disposed slidably in the guide groove 51 in a state where the projecting sections 50 are engaged in the engaging grooves 51a, and when the movable base member 10 is driven upwards or downwards by the hydraulic cylinder 11, the guide groove 12 guides the movable base member 10 such that it moves upwards or downwards with respect to the vice main body 2.

Next, the guiding and fixing mechanism 13 will be described.

The guiding and fixing mechanism 13 comprises a first serration 53 formed such that a plurality of teeth are provided in the lateral direction on the front side of the movable base member 10, a second serration 54 formed on the rear side of the movable clamp member 4 so as to be intermeshable with the first serration 53, a guide groove 55 formed in the movable base member 10 and extending in the vertical direction, an anchor member 56 disposed slidably in the guide groove 55, and two bolts 57 capable of fixing the movable clamp member 4 to the anchor member 56 in a state where the first and second serrations 53, 54 are intermeshed.

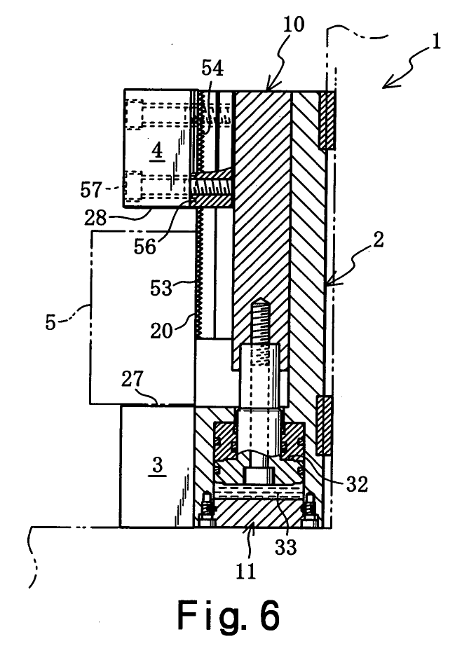

As shown in FIG. 4 and FIG. 6, the first serration 53 is formed along the whole length of the front side portion of the movable base member 10, in the vertical direction thereof. On the other hand, the second serration 54 is formed along the whole length of the rear side portion of the movable clamp member 4, in the vertical direction thereof In vertical cross-section, the first and second serrations are respectively formed in a triangular wave shape. By meshing the second serration 54 with the first serration 53, it is possible to position the movable clamp member 4 at a desired position on the movable base member 10.

As shown in FIG. 2 and FIG. 4, the guide groove 55 is formed on the front side of the movable base member 10 and is open towards the front side, and this guide groove 55 has a T shape in horizontal cross section, the vertical length of the guide groove 55 being the same as the vertical length of the first serration 53.

The vertical length of the anchor member 56 is virtually the same as the vertical length of the movable clamp member 4, the anchor member 56 being formed with a T shape in horizontal cross-section, and the anchor member 56 being guided movably in the vertical direction with respect to the movable base member 10, by means of the guide groove 55. The movable clamp member 4 can be fixed releasably to this anchor member 56 by means of two bolts 57, an upper and lower bolt.

When the two bolts 57 are loosened, the coupled state of the movable clamp member 4 and the anchor member 56 is maintained, whilst the meshing between the first and second serrations 53, 54 is released, and hence by moving the anchor member 56 guided by the guide groove 55 upwards or downwards, it is possible to move the movable clamp member 4 relatively upwards or downwards with respect to the movable base member 10.

Next, the action of the vice 1 will be described.

As shown in FIG. 6, in a state where no workpiece 5 has been set in the vice 1, and with the first and second serrations 53, 54 in an intermeshed state, the movable clamp member 4 is fixed to the anchor member 56 by the two bolts 57, and the movable clamp member 4 thus becomes fixed to the movable base member 10. From this state, for example, when a workpiece 5 of relatively short length in the vertical direction compared to the initial distance of separation between the fixed clamp member 3 and the movable clamp member 4 is to be fixed in the vice 1, the workpiece 5 is first placed such that it is abuts against the base surface 20 and the receiving surface 27, whereupon the two bolts 57 are loosened, and whilst maintaining the state of coupling of the movable clamp member 4 and the anchor member 56, the movable clamp member 4 is moved slightly away from the movable base member 10 in the forward direction, thereby releasing the meshed state between the first and second serrations 53, 54, and releasing the fixed state of the movable clamp member 4 and the movable base member 10. After releasing the fixing of the movable clamp member 4, the movable clamp member 4 is moved manually, together with the anchor member 56, in a downward direction with respect to the movable base member 10, to a position corresponding to the length of the workpiece 5 in the vertical direction, the movable clamp member 4 is advanced towards the workpiece 5, and the workpiece 5 is substantially held between the fixed clamp member 3 and the movable clamp member 4. Thereupon, after meshing the first and second serrations 53, 54, the two bolts 57 are tightened up, thereby fixing the movable clamp member 4 to the movable base member 10.

In this state, a clamping force is generated by supplying hydraulic pressure to the clamping side oil chamber 32, and when the piston 37 is pushed downwards by this clamping force, the movable base member 10 is also driven downwards, the movable clamp member 4 which is fixed to the movable base member 10 is also driven downwards, and the workpiece 5 becomes held and fixed tightly between the fixed clamp member 3 and the movable clamp member 4.

When the workpiece 5 is to be released, the hydraulic pressure in the clamping side oil chamber 32 is discharged, and at the same time, a hydraulic pressure is supplied to the clamp releasing side oil chamber 33, thus generating a clamp releasing force, and when the piston 37 is pushed upwards by this clamp releasing force, the movable base member 10 is also driven upwards, and the movable clamp member 4 is also driven upwards accordingly, thereby releasing the fixing of the workpiece 5.

If the length of the workpiece 5 in the vertical direction is relatively large, then the workpiece 5 is set after moving the movable clamp member 4 upwards, whereupon the workpiece 5 can be held by subsequently moving the movable clamp member 4 downwards.

According to the vice 1 described above, the following advantages can be obtained.

By moving the movable clamp member 4 upwards with respect to the movable base member 10 and then fixing the movable clamp member 4 to the anchor member 56 by means of the two bolts 57, in a state where the first and second serrations 53, 54 are intermeshed, then it is possible to fix the movable clamp member 4 at a desired position on the movable base member 10, in accordance with the size of the workpiece 5. Consequently, since it is possible to fix the workpiece 5 by driving the movable clamp member 4 downwards by means of a hydraulic cylinder 11, after holding the workpiece 5 substantially between the fixed clamp member 3 and the movable clamp member 4, this being possible for workpieces 5 of various sizes, then the stroke of the hydraulic cylinder 11 can be shortened. Therefore, the vice 1 can be made more compact, and benefits in terms of equipment costs can also be obtained.

Moreover, since it is possible to hold a workpiece 5 substantially between the fixed clamp member 3 and the movable clamp member 4, simply by moving the movable clamp member 4 only, which is relatively light in weight, before fixing the workpiece 5, then it is possible to raise the efficiency of the task of fixing the workpiece 5, and hence the burden on the operator can be reduced.

Furthermore, since the movable clamp member 4 can be fixed at a desired position on the movable base member 10, by fastening the two bolts 57 after meshing together the first and second serrations 53, 54, and since this fixing can be released simply by loosening the two bolts 57, then no special mechanism is required for releasing this fixing, and hence the structure of the guiding and fixing mechanism 13 can be simplified. Moreover, the vice 1 can be formed with a simple external shape, and hence it becomes possible to remove chippings, and the like, generated by machining, from the vice 1, easily.

Members of various shapes corresponding to the shape of the workpieces 5 to be fixed may be used for the fixed clamp member 3 and the movable clamp member 4. Since these members can be exchanged simply by removing bolts 26 and 57, the task of exchanging these members can be performed in a relatively simple manner. Furthermore, a pneumatic cylinder may also be used as a fluid pressure cylinder for driving the movable base member 10. Moreover, in the embodiment described above, the present invention was applied to an vertical type vice, but the present invention may, of course, also be applied to a horizontal type vice. Furthermore, the first and second serrations 53, 54 are not limited to the shapes described in the foregoing embodiment, it will be possible to adopt serrations of various shapes, provided that they are mutually intermeshing and allow the movable clamp member 4 to position with respect to the movable base member 10, for instance, serrations having a saw tooth shape in vertical cross section, or the like.

The present invention is not limited to the embodiments described above, and a person skilled in the art may make various modifications to the foregoing embodiment, within a scope that does not deviate from the essence of the present invention, all such modifications being encompassed by the present invention.

Industrial Applicability

The vice according to the present invention may be applied to a work fixing vice installed on a workpiece fixing device, workpiece pallet, or the like, for fixing a workpiece that is to be machined by machine tools of various kinds, having a horizontal or vertical main spindle.

1. A vice comprising:
a vice main body having a base surface whereon a workpiece can be set;
a fixed clamp member provided in a fixed manner on the vice main body;
a movable clamp member capable of moving in a prescribed direction towards or away from the fixed clamp member while keeping its face toward same;
a movable base member disposed inside the vice main body and having a length in said prescribed direction;
a fluid pressure cylinder capable of driving the movable base member in said prescribed direction;
a guiding mechanism for guiding the movable base member movably in said prescribed direction, with respect to said vice main body; and
a guiding and fixing mechanism capable of guiding said movable clamp member movably in said prescribed direction with respect to the movable base member, and capable of fixing said movable clamp member in a releasable fashion.

2. The vice according to claim 1, wherein said guiding and fixing mechanism comprises: a first serration formed such that a plurality of teeth are provided orthogonally to said prescribed direction, in the side of the base surface of the movable base member; a second serration formed in the side of the base surface of the movable clamp member so as to be intermeshable with said first serration; a guide groove formed in the movable base member and extending in said prescribed direction; an anchor member disposed slidably in this guiding groove; and a plurality of bolts capable of fixing the movable clamp member to the anchor member in a state where the first and second serrations are intermeshed.

3. The vice according to claim 2, whereby, after releasing the fixing of the movable clamp member by means of said guiding and fixing mechanism, the movable clamp member is moved relatively together with the anchor member, with respect to the movable base member, a workpiece is held substantially between the fixed clamp member and the movable clamp member, and the first and second serrations are caused to intermesh, whereupon the movable clamp member is fixed to the movable base member by means of said plurality of bolts.

4. The device according to claim 1, wherein said fluid pressure cylinder is a hydraulic cylinder.

5. The device according to claim 2, wherein said fluid pressure cylinder is a hydraulic cylinder.

6. The vice according to claim 3, wherein said fluid pressure cylinder is a hydraulic cylinder.
